(19) United States
(12) Patent Application Publication
(10) Pub. No.: US 2022/0191788 A1
(43) Pub. Date: Jun. 16, 2022

(54) PERMISSIBLE TRANSMISSION GAP ASSISTANCE BY UE

(71) Applicant: Telefonaktiebolaget LM Ericsson (publ), Stockholm (SE)

(72) Inventors: Martin van der Zee, Malmö (SE); Sina Maleki, Malmö (SE); Andres Reial, Lomma (SE)

(21) Appl. No.: 17/598,258

(22) PCT Filed: Mar. 20, 2020
(86) PCT No.: PCT/IB2020/052643

§ 371 Date: Sep. 25, 2021

Related U.S. Application Data
(60) Provisional application No. 62/825,461, filed on Mar. 28, 2019.

(51) Int. Cl. H04W 52/02

(52) U.S. Cl. CPC H04W 52/0216; H04W 52/0229

(57) ABSTRACT

Systems and methods related to permissible transmission gap assistance information provided by a wireless device (e.g., a User Equipment (UE)) to a base station in a cellular communications network are disclosed. In one embodiment, a method performed by a wireless device for a cellular communications network comprises determining a transmission gap for the wireless device. The transmission gap is a time gap during which no uplink or downlink data transmission is anticipated or required by the wireless device. The method further comprises transmitting information comprising an indication of the transmission gap to a network node. In this manner, information is provided to the network node that enables scheduling uplink and downlink data transmissions to the wireless device during the transmission gap, thereby enabling the wireless device to reduce power consumption by, e.g., entering a sleep state during the transmission gap.

### RELATED APPLICATIONS

This application claims the benefit of provisional patent application Ser. No. 62/825,461, filed Mar. 28, 2019, the disclosure of which is hereby incorporated herein by reference in its entirety.

### TECHNICAL FIELD

The present disclosure relates to a cellular communications network and, more specifically, to assistance information provided from the User Equipment (UE) to the network for reducing Physical Downlink Control Channel (PDCCH) monitoring by the UE.

### BACKGROUND

In regard to Third Generation Partnership Project (3GPP) networks such as, e.g., a Long Term Evolution (LTE) network (i.e., an Evolved Universal Terrestrial Radio Access Network (E-UTRAN)) and a Fifth Generation (5G) New Radio (NR) network, high-level User Equipment (UE) energy consumption profiling indicates that dominant UE energy consumption is associated with Physical Downlink Control Channel (PDCCH) monitoring during active data reception periods. A UE could reduce such energy consumption by avoiding frequent PDCCH monitoring during periods when no data is actually being transferred. Today, some mechanisms exist or are being considered in 3GPP for that purpose. This may be done using, e.g., Go-To-Sleep (GTS) signaling, PDCCH search space reconfiguration, etc. Also, a PDCCH skipping feature has been proposed.

To achieve maximal PDCCH monitoring reduction while avoiding missed monitoring when data actually arrive, PDCCH signaling adaptation requires reliable information about the expected traffic arrival gap(s). Regarding available expected traffic information, the network can collect traffic pattern statistics for different UEs, e.g. at the time scale of minutes. Regarding instantaneous traffic status, the network knows the downlink (DL) buffer state and can receive an uplink (UL) Beam Reference Signal (BRS) from the UE. End of Traffic Burst (EOTB) signaling may also be a way for a UE to instantly inform the network that no immediate additional UL/DL data is expected to be generated by the UE or for the UE. The network may then use that information to transition to periodic Connected Mode Discontinuous Reception (CDRX).

There currently exist certain challenge(s). Basing PDCCH monitoring reduction (e.g., stopping PDCCH monitoring temporarily or making it sparse) on statistical information is typically not reliable, at least if the variance of traffic burst inter-arrival times is high. This may occur if, for example, the UE is operating using a mix of traffic sources (e.g., multiple smartphone applications).

For the purposes of determining the instantaneous expected data arrival gap, the network can estimate data delivery to Layer 1 (L1) (i.e., the physical layer) based on instantaneous DL and UL buffer states. The instantaneous DL and UL buffer states, combined with the scheduler state and resulting scheduling delays, allow near-term data transmission at L1 to be partially predicted. However, the network lacks reliable ways to predict future data arrival events, even in the short-term.

EOTB signaling by the UE has been proposed as a way for the UE to assist the network whereby the UE may, e.g., consult the application layer and indicate that no further data arrival is expected. Unfortunately, the UE may not able to obtain particularly reliable information from the application layer (e.g., one or more applications that are active in a smartphone, or a measurement reporting software in a sensor) regarding the next expected traffic burst, perhaps simply since no such guarantees can be given due to the stochastic nature of the processes that generate the traffic. Furthermore, the EOTB is designed to provide a release assistance function, i.e. transition to periodic CDRX or into idle/inactive.

Thus, there is a need for new types of assistance information that are useful for PDCCH monitoring reduction.

### SUMMARY

Systems and methods related to permissible transmission gap assistance information provided by a wireless device (e.g., a User Equipment (UE)) to a base station in a cellular communications network are provided herein. In one embodiment, a method performed by a wireless device for a cellular communications network comprises determining a transmission gap for the wireless device. The transmission gap is a time gap during which no uplink (UL) or downlink (DL) data transmission is anticipated or required by the wireless device. The method further comprises transmitting information comprising an indication of the transmission gap to a network node. In this manner, information is provided to the network node that enables scheduling UL and DL data transmissions to the wireless device during the transmission gap, thereby enabling the wireless device to reduce power consumption by, e.g., entering a sleep state during the transmission gap.

In one embodiment, any transmission by the wireless device of any data generated during the time gap and any reception by the wireless device of any data generated during the time gap can be delayed until after the transmission gap.

In one embodiment, determining the transmission gap for the wireless device comprises determining a length of the transmission gap.

In one embodiment, the indication is a one-time indication of the transmission gap.

In one embodiment, the indication serves as an indication that the indicated transmission gap is valid in one or more upcoming Physical Downlink Control Channel (PDCCH) monitoring occasions. In one embodiment, the indication of the transmission gap indicates a length of the transmission gap as a number of time slots.

In one embodiment, the indication of the transmission gap indicates a length of the transmission gap as a number of milliseconds.

In one embodiment, the method further comprises receiving, from the network node, a PDCCH monitoring configuration message that changes a current PDCCH monitoring mode of the wireless device to a new PDCCH monitoring mode. In one embodiment, the new PDCCH monitoring mode provides less frequent PDCCH monitoring occasions than the current PDCCH monitoring mode. In one embodiment, the new PDCCH monitoring mode provides cross-slot scheduling.

In one embodiment, the method further comprises receiving, from the network node, a PDCCH monitoring configuration message that changes a current PDCCH monitoring mode of the wireless device to a new PDCCH monitoring mode that grants the transmission gap indicated by the wireless device.

In one embodiment, the method further comprises going into a sleep state for the transmission gap.

In one embodiment, determining the transmission gap comprises determining the transmission gap based on: (a) tolerated latency for a transmission, (b) predicted traffic burst arrival, (c) predicted UL traffic burst, or (d) any combination of two or more of a-c.

In one embodiment, transmitting the information comprises transmitting the information over a Physical Uplink Control Channel (PUCCH) or a Physical Uplink Shared Channel (PUSCH). In one embodiment, transmitting the information comprises transmitting the information in a Medium Access Control (MAC) Control Element (CE).

In one embodiment, the time gap is a remainder of a current Inter-Arrival Time (IAT) or a reminder of a current Connected Mode Discontinuous Reception (CDRX) period.

In one embodiment, the time gap extends to a beginning of a next CDRX ON duration.

In one embodiment, the indication of the transmission gap is a dynamic indication. In another embodiment, the indication of the transmission gap is a semi-static indication.

Corresponding embodiments of a wireless device are also disclosed. In one embodiment, a wireless device for a cellular communications network is adapted to determine a transmission gap for the wireless device, where the transmission gap is a time gap during which no UL or DL data transmission is anticipated or required by the wireless device. The wireless device is further adapted to transmit information comprising an indication of the transmission gap to a network node.

In one embodiment, the wireless device comprises one or more transmitters, one or more receivers, and processing circuitry associated with the one or more transmitters and the one or more receivers. The processing circuitry is configured to cause the wireless device to determine the transmission gap for the wireless device and transmit the information comprising the indication of the transmission gap to the network node.

Embodiments of a method performed by a base station are also disclosed. In one embodiment, a method performed by a base station for a cellular communications network comprises receiving, from a wireless device, information comprising an indication of a transmission gap, where the transmission gap is a time gap during which no UL or DL data transmission is anticipated or required by the wireless device. The method further comprises determining a PDCCH monitoring mode for the wireless device to accommodate the indicated transmission gap and transmitting a configuration of the determined PDCCH monitoring mode to the wireless device.

In one embodiment, the configuration of the determined PDCCH monitoring mode comprises a Go-To-Sleep (GTS) signal that puts the wireless device in a lower energy consumption state for a duration of the indicated transmission gap.

In one embodiment, the configuration of the determined PDCCH monitoring mode includes a PDCCH skipping command that reduces energy consumption for a duration of the indicated transmission gap.

In one embodiment, the configuration of the determined PDCCH monitoring mode includes configuring a configuration of a sparser PDCCH search space that reduces energy consumption for a duration of the indicated transmission gap.

In one embodiment, the configuration of the determined PDCCH monitoring mode includes configuring a configuration of cross-slot scheduling that reduces energy consumption for a duration of the indicated transmission gap.

In one embodiment, the method further comprises configuring the wireless device to transmit the information comprising the indication of the transmission gap to the base station.

In one embodiment, the method further comprises configuring the wireless device to transmit the information comprising the indication of the transmission gap at an aperiodic rate.

Corresponding embodiments of a base station are also disclosed. In one embodiment, a base station for a cellular communications network is adapted to receive, from a wireless device, information comprising an indication of a transmission gap, where the transmission gap is a time gap during which no UL or DL data transmission is anticipated or required by the wireless device. The base station is further adapted to determine a PDCCH monitoring mode for the wireless device to accommodate the indicated transmission gap and transmit a configuration of the determined PDCCH monitoring mode to the wireless device.

In one embodiment, the base station comprises processing circuitry configured to cause the base station to receive, from the wireless device, the information comprising the indication of the transmission gap, determine the PDCCH monitoring mode for the wireless device to accommodate the indicated transmission gap, and transmit the configuration of the determined PDCCH monitoring mode to the wireless device.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates one example of a cellular communications network in which embodiments of the present disclosure may be implemented;

FIG. 2 is a flow chart that illustrates the operation of a User Equipment (UE) in accordance with an embodiment of the present disclosure;

FIG. 3 is a flow chart that illustrates the operation of a network node in accordance with one embodiment of the present disclosure;

FIGS. 4 through 6 are schematic block diagrams of example embodiments of a network node; and

FIGS. 7 and 8 are schematic block diagrams of example embodiments of a UE.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Radio Node: As used herein, a “radio node” is either a radio access node or a wireless device.

Radio Access Node: As used herein, a “radio access node” or “radio network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP), Fifth Generation (5G) NR network, or an enhanced or evolved Node B (eNB) in a 3GPP Long Term Evolution (LTE) network), a high-power or macro base station, a low-power base station (e.g., a micro base station, a pico base station, a home eNB, or the like), and a relay node.

Core Network Node: As used herein, a “core network node” is any type of node in a core network. Some examples of a core network node include, e.g., a Mobility Management Entity (MME), a Packet Data Network Gateway (P-GW), a Service Capability Exposure Function (SCEF), or the like.

Wireless Device: As used herein, a “wireless device” is any type of device that has access to (i.e., is served by) a cellular communications network by wirelessly transmitting and/or receiving signals to a radio access node(s). Some examples of a wireless device include, but are not limited to, a User Equipment device (UE) in a 3GPP network and a Machine Type Communication (MTC) device.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

Certain aspects of the present disclosure and the embodiments described herein may provide solutions to the aforementioned or other challenges related to Physical Downlink Control Channel (PDCCH) monitoring reduction. The UE provides assistance information to the network indicating that any transmission/reception (where “transmission/reception” denotes “transmission or reception”) can be delayed for the duration of a specified time gap, i.e. no uplink (UL) or downlink (DL) data transmission is anticipated or required during the gap by the UE. This assistance information is referred to herein as Permissible Transmission Gap (PTG) assistance information. The gap length may be given explicitly (e.g., slots or milliseconds). It need not be distinguished whether the specified gap is due to establishing that no traffic will be generated, or that the UE accepts any delays incurred if any traffic generated during the gap is delivered after the end of the gap.

For the network, the assistance information means that, from the UE's viewpoint, no scheduling PDCCH transmission needs to be performed during the gap. Any DL data arriving during the gap can be scheduled after the end of the gap without adverse impact to the UE. The network (e.g., base station/network node) determines whether to consider the assistance information and may configure the UE with reduced or omitted PDCCH monitoring for the specified gap (or other) interval.

A PTG signaled by the UE may be transmitted as a one-time indication or as an indication that the permissible gap value (i.e., the permissible gap length) may be also applied by the network in upcoming PDCCH monitoring occasions, e.g. during a specified time duration or until further notice. The network may signal PDCCH monitoring reduction at each occasion it is applied.

There are, proposed herein, various embodiments which address one or more of the issues disclosed herein. For example, a method performed by a wireless device (e.g., a UE) (e.g., for reducing energy consumption of the wireless device) in a wireless communication network is provided. The method includes determining a permissible transmission gap length, e.g., based on tolerated latency, predicted burst arrival, predicted UL traffic burst, and/or the like. The method further includes signaling an indication of the permissible transmission gap to a network node (e.g., a base station). This is also referred to herein as signaling permissible transmission gap assistance information to the network node. In some embodiments, the method further comprises receiving a DL control channel configuration from the network node.

In other words, in some embodiments, a method performed by a wireless device (e.g., for reducing energy consumption) comprises generating a signal indicating that transmission and/or reception can be delayed for a duration of a specified time gap. The method further includes a step of transmitting the signal wirelessly to the base station/network. Generating the signal indicating that transmission and/or reception can be delayed for a duration of a specified time gap may include determining a permissible transmission gap based on tolerated latency, predicted traffic burst arrival, or predicted UL traffic burst generation.

Embodiments of a method of operation of a network node (e.g., a base station) are also disclosed. In some embodiments, a method of operation of a network node comprises receiving, from a wireless device (e.g., a UE), an indication of a permissible transmission gap (e.g., receiving permissible transmission gap assistance information). The permissible transmission gap is a time period until a next transmission to or from the wireless device that is acceptable (i.e., permissible) to the wireless device. A transmission gap is “acceptable” or “permissible” to the wireless device during a time gap during which UL or DL transmission is anticipated or required by the wireless device. Note, however, that the wireless device may still perform some DL and/or UL operations (e.g., Channel State Information (CSI) measurement and reporting) during the transmission gap. In some embodiments, the network node determines a DL control channel monitoring mode (e.g., a specific PDCCH measurement object configuration) for the wireless device based on the permissible transmission gap. In some embodiments, the network node transmits a DL control channel configuration (e.g., a specific PDCCH measurement object configuration) to the wireless device. This DL control channel configuration is for the determined DL control channel monitoring mode.

In other words, in some embodiments, a method performed by a network node (e.g., a base station) (e.g., for reducing energy consumption of a wireless device (e.g., UE)) is provided. In some embodiments, the method includes receiving from the wireless device a signal indicating that transmission and/or reception can be delayed for a duration of a specified time gap. In some embodiments, the method further includes determining a new PDCCH monitoring mode for the wireless device to accommodate the specified time gap. In some embodiments, the method further includes transmitting a configuration for the new PDCCH monitoring mode to the wireless device.

Certain embodiments may provide one or more of the following technical advantage(s). The PTG signaling, indicating a permitted delay until the next traffic transmission, differs from End of Traffic Burst (EOTB) signaling, which according to current formulation is aimed solely at indicating that the current traffic burst has ended and that no more immediate data transmission is expected, without specifying an anticipated or tolerated delay until starting a new data transmission or reception for the next traffic slot or burst.

The PTG assistance information allows the UE to indicate to the network that data transmission may be omitted during a specified gap duration, where this indication is not limited to the assumption that there likely will be no data, but is additionally based on the consideration that a certain level of delay is acceptable even if data bursts are generated in the meantime. If the network adopts configuration and scheduling in accordance with the PTG assistance information, this widens the opportunity for UE energy saving during PDCCH monitoring in connection to active data transmission.

The PTG assistance information may be used by a variety of PDCCH monitoring adaptation mechanisms.

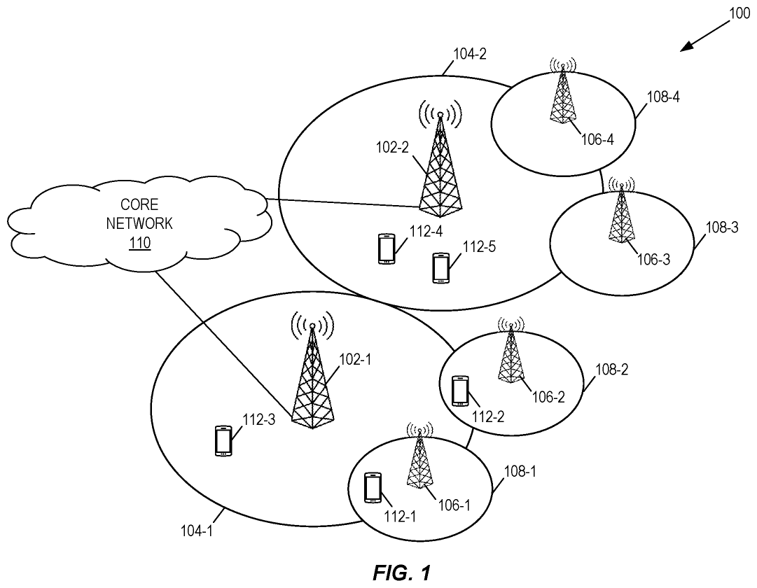

FIG. 1 illustrates one example of a cellular communications network 100 according to some embodiments of the present disclosure. In the embodiments described herein, the cellular communications network 100 is a LTE or 5G NR network. In this example, the cellular communications network 100 includes base stations 102-1 and 102-2, which in LTE are referred to as eNBs and in 5G NR are referred to as gNBs, controlling corresponding macro cells 104-1 and 104-2. The base stations 102-1 and 102-2 are generally referred to herein collectively as base stations 102 and individually as base station 102. Likewise, the macro cells 104-1 and 104-2 are generally referred to herein collectively as macro cells 104 and individually as macro cell 104. The cellular communications network 100 may also include a number of low power nodes 106-1 through 106-4 controlling corresponding small cells 108-1 through 108-4. The low power nodes 106-1 through 106-4 can be small base stations (such as pico or femto base stations) or Remote Radio Heads (RRHs), or the like. Notably, while not illustrated, one or more of the small cells 108-1 through 108-4 may alternatively be provided by the base stations 102. The low power nodes 106-1 through 106-4 are generally referred to herein collectively as low power nodes 106 and individually as low power node 106. Likewise, the small cells 108-1 through 108-4 are generally referred to herein collectively as small cells 108 and individually as small cell 108. The base stations 102 (and optionally the low power nodes 106) are connected to a core network 110.

The base stations 102 and the low power nodes 106 provide service to wireless devices 112-1 through 112-5 in the corresponding cells 104 and 108. The wireless devices 112-1 through 112-5 are generally referred to herein collectively as wireless devices 112 and individually as wireless device 112. The wireless devices 112 are also sometimes referred to herein as UEs.

Now, a description of some example embodiments of the present disclosure will be provided. With the PTG assistance signaling, the UE indicates how long a transmission gap to request and how much of a corresponding PDCCH monitoring gap is desired. In other words, by indicating the PTG to the network, the UE indicates a duration of time (i.e., the PTG) during which it is acceptable for the UE to not transmit data to the network and not receive data from the network. The indicated PTG thus indicates a corresponding PDCCH monitoring gap that is acceptable to the UE. The transmission gap may be accepted by the network based on expected traffic generation and/or permissible data delivery latency. Note that the network does not need to formally accept or acknowledge the UE's proposed permissible transmission gap. Rather, the network accepts it by using it for scheduling the UE appropriately. The network may choose to use the assistance information to adapt PDCCH monitoring for the UE according to multiple adaptation schemes.

One motivation for providing PTG assistance signaling is that, even with a time gap of a few slots or milliseconds, the UE can micro-sleep and save energy. A delay of a few slots or milliseconds does not typically influence the user experience of many data-oriented services and is an acceptable delay even when data bursts are being generated. The present disclosure primarily targets indicating transmission gaps on the order of a few to a few tens of milliseconds. Typically transmission gaps will be shorter than an Inter Arrival Time (IAT) (e.g., up to 100 milliseconds (ms)) or a Connected Mode Discontinuous Reception (CDRX) period (100-300 ms). Small access delays of a few milliseconds are tolerable for most use cases.

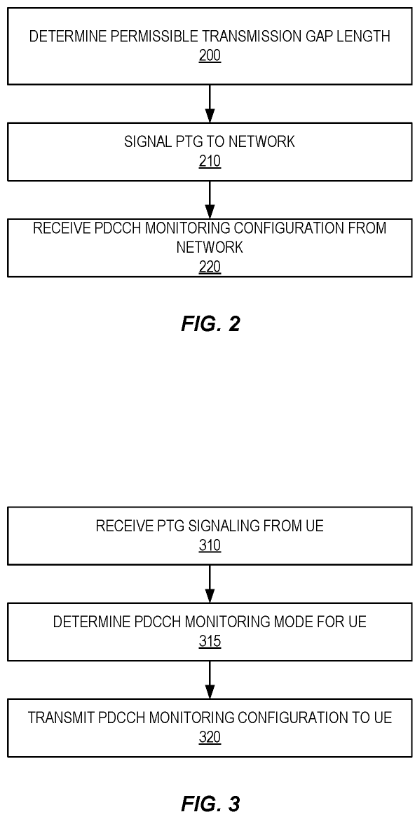

FIG. 2 is a flow chart that illustrates the operation of a UE in accordance with an embodiment of the present disclosure. The UE may be, e.g., a wireless device 112 in the network 100 of FIG. 1. As depicted in FIG. 2, in a step 200, the UE determines a permissible transmission gap length. The determination may be based on tolerated latency, predicted traffic burst arrival, predicted uplink traffic burst, etc. For instance, the UE obtains current latency/delay constraints from application traffic pattern information (i.e., traffic pattern information for one or more applications executing at the UE), or next packet estimate (i.e., an estimate of when a next packet may be expected to be transmitted/received by the UE), etc. The UE determines a permissible gap (i.e., a PTG or PTG length) until a next transmission, including potentially determining the trade-off between available energy savings and possible delay and its impact on data transmission. The gap length may be specified in absolute numbers (i.e., number of slots or milliseconds) or may include the rest of the IAT duration or the rest of the CDRX period (especially if the latter is short).

In a step 210, the UE provides PTG assistance signaling to the network, using, e.g., Uplink Control Information (UCI) over Physical Uplink Control Channel (PUCCH)/Physical Uplink Shared Channel (PUSCH) or Medium Access Control (MAC) Control Element (CE). In other words, the UE provides a message or information to the network that includes PTG assistance information. The PTG assistance information may convey the permissible gap length in slots, milliseconds, etc., or, e.g., that the permissible gap extends to the beginning of the next CDRX ON-duration. The PTG assistance signaling (e.g., the PTG assistance information) may be transmitted as a one-time indication. Alternatively, it may be transmitted as an indication that the permissible gap value (i.e., the PTG length) may also be considered valid by the network in upcoming PDCCH monitoring occasions; the validity may be indicated as a time duration or until further notice.

The PTG does not necessarily have to be signaled “dynamically”, i.e. it could also be signaled via semi-static Radio Resource Control (RRC) UE assistance information, where the UE indicates “I expect not to have more data for x slots after sending BSR=0” or “I can tolerate x slots of delay after having sent BSR=0”, where BSR refers to “buffer status report”. The PTG assistance information can also be sent together with BSR=0 signaling.

In a step 220, which is optional, the UE may receive a PDCCH monitoring configuration message that changes the current PDCCH monitoring mode of the UE. This message can be included as Downlink Control Information (DCI) sent over specific PDCCH (e.g., a DCI based PDCCH skipping command based on existing mechanisms), or multiplexed with PUSCH). Additional possibilities can be through indication-based approaches, e.g. if the UE receives the first PDCCH after signaling the PTG to the network in a specific Synchronization Signal (SS)/Control Resource Set (CORESET), then the UE interprets this to mean that the PDCCH monitoring can be reconfigured according to a network pre-configured switching pattern. Alternatively, a timer-based approach can be used after signaling the PTG to the network such that, if the UE has not received any scheduling PDCCH within N number of slots, or a time lapse, then the UE can assume that the PTG is confirmed by the network, wherein N is a counting number.

Furthermore, in case the network has a concurrent non-data scheduling PDCCH (e.g., an aperiodic CSI report, handover, etc.), then the network can send the PDCCH monitoring configuration message after the end of the concurrent procedure. In case the timer-based approach discussed above is used, then the UE can start the timer after the end of the concurrent procedure.

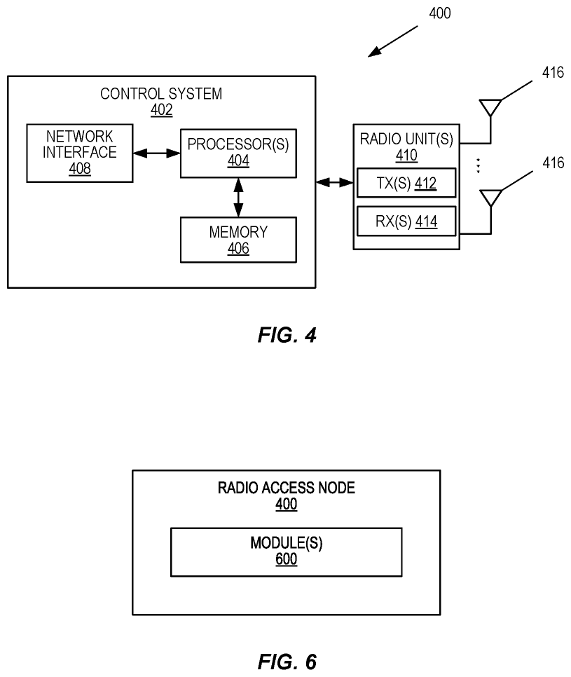

FIG. 3 is a flow chart that illustrates the operation of a network node in accordance with one embodiment of the present disclosure. As depicted in FIG. 3, in a step 310, the network node receives PTG signaling (which is also referred to herein as PTG assistance signaling) from the UE, for the current time instant or valid for a longer time period. The PTG signaling may comprise a PTG value or length, for example.

In step 315, the network node determines a PDCCH monitoring mode for the UE. More specifically, the network determines whether the PTG value should be applied to the upcoming PDCCH monitoring. If applying the PTG value does not incur adverse network impact, the network node may consider applying the PTG value and determine a PDCCH monitoring mode that allows the UE to operate at a lower power/energy level during the PTG duration. The PDCCH monitoring mode selection may include transmitting a Go-To-Sleep (GTS) signal, transmitting a PDCCH skipping command, configuring a sparser search space, configuring cross-slot scheduling, etc. If there would be an adverse impact from delaying potential traffic bursts that occur during a gap (e.g., less efficient scheduler utilization, or undesirable signaling overhead), the network node may ignore the PTG signaling. Alternatively, the network node can configure a PTG timer such that the UE can switch to a preconfigured PDCCH monitoring mode after the PTG timer is expired and no scheduling PDCCH is received in that period.

In a step 320, which is optional, if the mode determined in step 315 differs from the current mode, the network node configures the UE to operate using the PDCCH monitoring mode determined in step 315.

The naming of the proposed PTG assistance signal has not been agreed at 3GPP. An eventual agreement may use other wording, e.g. “Delay Tolerance Indicator” (DTI), “Tolerable Transmission Jitter” (TTJ), “Access Delay Tolerance” (ADT), etc. (non-exhaustive list).

A single PTG assistance signal may be transmitted, conveying aggregated EOTB and PTG. Alternatively, EOTB and PTG may be provided separately, signifying traffic gap prediction and transmission gap permission, respectively.

The network can configure the PTG through RRC reconfiguration or deactivate the PTG if it wishes so through the same procedure. In other words, the network can configure the PTG through RRC reconfiguration or deactivate the PTG if the network determines a configuration, reconfiguration, or deactivation should occur by using the same procedure(s). For example, if the UE is expected to receive critical information, the network does not configure the PTG; but if the UE is intended for non-critical information, then the network configures the PTG. Furthermore, the network can configure the UE to send the PTG signal in specific PTG occasions (e.g., in a periodic or aperiodic manner). A PTG occasion is a time-frequency resource in which PTG signaling can be transmitted by the UE.

As mentioned before, the PTG signal can be sent over different channels, e.g. PUCCH and PUSCH. However, since PUCCH resources are limited, it would be more beneficial to use PUSCH since there are more resources. The UE can, e.g., multiplex the PTG signal in the last PUSCH, or send an independent PUSCH for the PTG.

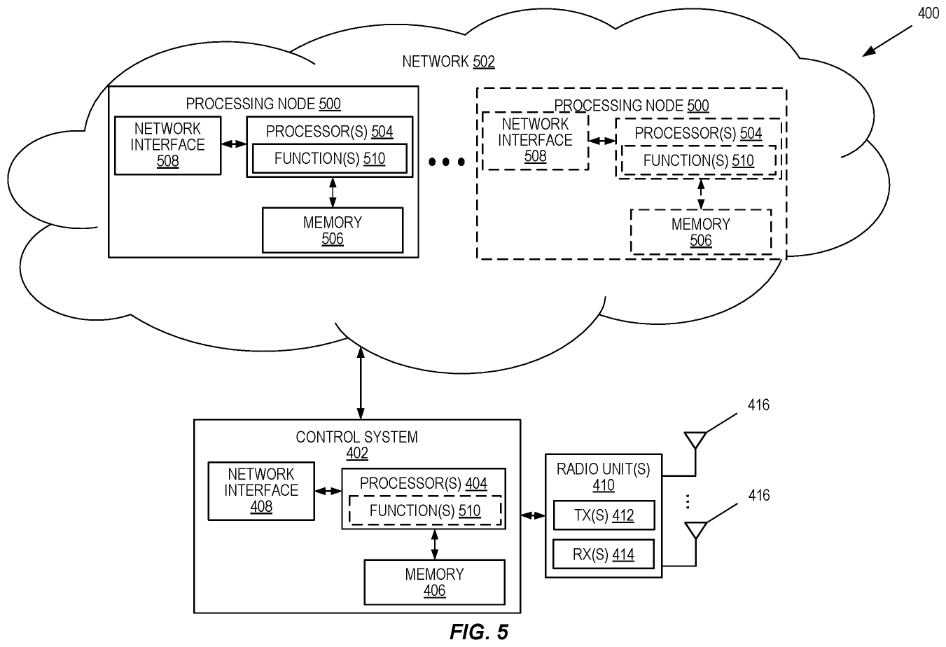

FIG. 4 is a schematic block diagram of a radio access node 400 according to some embodiments of the present disclosure. The radio access node 400 may be, for example, a base station 102 or 106. As illustrated, the radio access node 400 includes a control system 402 that includes one or more processors 404 (e.g., Central Processing Units (CPUs), Application Specific Integrated Circuits (ASICs), Field Programmable Gate Arrays (FPGAs), and/or the like), memory 406, and a network interface 408. The one or more processors 404 are also referred to herein as processing circuitry. In addition, the radio access node 400 includes one or more radio units 410 that each includes one or more transmitters 412 and one or more receivers 414 coupled to one or more antennas 416. The radio units 410 may be referred to or be part of radio interface circuitry. In some embodiments, the radio unit(s) 410 is external to the control system 402 and connected to the control system 402 via, e.g., a wired connection (e.g., an optical cable). However, in some other embodiments, the radio unit(s) 410 and potentially the antenna(s) 416 are integrated together with the control system 402. The one or more processors 404 operate to provide one or more functions of a radio access node 400 (e.g., one or more functions of the network node as described herein with respect to FIG. 3) as described herein. In some embodiments, the function(s) are implemented in software that is stored, e.g., in the memory 406 and executed by the one or more processors 404.

FIG. 5 is a schematic block diagram that illustrates a virtualized embodiment of the radio access node 400 according to some embodiments of the present disclosure. This discussion is equally applicable to other types of network nodes. Further, other types of network nodes may have similar virtualized architectures.

As used herein, a “virtualized” radio access node is an implementation of the radio access node 400 in which at least a portion of the functionality of the radio access node 400 is implemented as a virtual component(s) (e.g., via a virtual machine(s) executing on a physical processing node(s) in a network(s)). As illustrated, in this example, the radio access node 400 includes the control system 402 that includes the one or more processors 404 (e.g., CPUs, ASICs, FPGAs, and/or the like), the memory 406, and the network interface 408 and the one or more radio units 410 that each includes the one or more transmitters 412 and the one or more receivers 414 coupled to the one or more antennas 416, as described above. The control system 402 is connected to the radio unit(s) 410 via, for example, an optical cable or the like. The control system 402 is connected to one or more processing nodes 500 coupled to or included as part of a network(s) 502 via the network interface 408. Each processing node 500 includes one or more processors 504 (e.g., CPUs, ASICs, FPGAs, and/or the like), memory 506, and a network interface 508.

In this example, functions 510 of the radio access node 400 described herein (e.g., one or more functions of the network node as described herein with respect to FIG. 3) are implemented at the one or more processing nodes 500 or distributed across the control system 402 and the one or more processing nodes 500 in any desired manner. In some particular embodiments, some or all of the functions 510 of the radio access node 400 described herein are implemented as virtual components executed by one or more virtual machines implemented in a virtual environment(s) hosted by the processing node(s) 500. As will be appreciated by one of ordinary skill in the art, additional signaling or communication between the processing node(s) 500 and the control system 402 is used in order to carry out at least some of the desired functions 510. Notably, in some embodiments, the control system 402 may not be included, in which case the radio unit(s) 410 communicate directly with the processing node(s) 500 via an appropriate network interface(s).

In some embodiments, a computer program including instructions which, when executed by at least one processor, causes the at least one processor to carry out the functionality of radio access node 400 or a node (e.g., a processing node 500) implementing one or more of the functions 510 of the radio access node 400 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 6 is a schematic block diagram of the radio access node 400 according to some other embodiments of the present disclosure. The radio access node 400 includes one or more modules 600, each of which is implemented in software. The module(s) 600 provide the functionality of the radio access node 400 described herein (e.g., one or more functions of the network node as described herein with respect to FIG. 3). This discussion is equally applicable to the processing node 500 of FIG. 5 where the modules 600 may be implemented at one of the processing nodes 500 or distributed across multiple processing nodes 500 and/or distributed across the processing node(s) 500 and the control system 402.

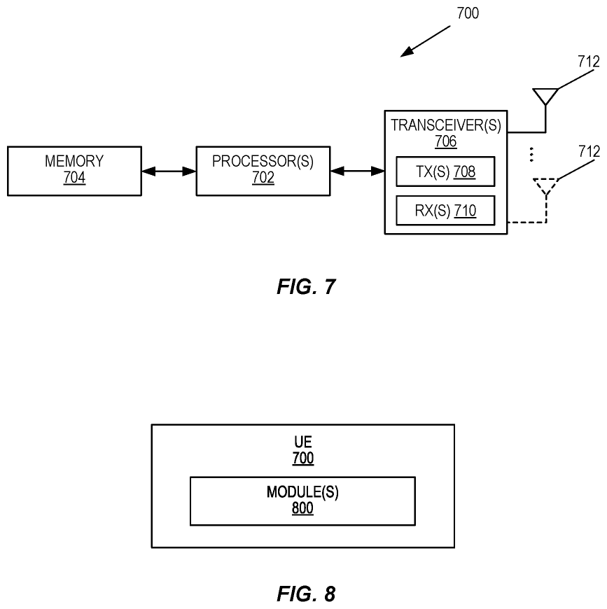

FIG. 7 is a schematic block diagram of a UE/wireless device 700 according to some embodiments of the present disclosure. As illustrated, the UE 700 includes one or more processors 702 (e.g., CPUs, ASICs, FPGAs, and/or the like), memory 704, and one or more transceivers 706 each including one or more transmitters 708 and one or more receivers 710 coupled to one or more antennas 712. The transceiver(s) 706 includes radio-front end circuitry connected to the antenna(s) 712 that is configured to condition signals communicated between the antenna(s) 712 and the processor(s) 702, as will be appreciated by one of ordinary skill in the art. The processors 702 are also referred to herein as processing circuitry. The transceivers 706 are also referred to herein as radio circuitry. In some embodiments, the functionality of the UE 700 described above (e.g., one or more functions of the UE as described herein with respect to FIG. 2) may be fully or partially implemented in software that is, e.g., stored in the memory 704 and executed by the processor(s) 702. Note that the UE 700 may include additional components not illustrated in FIG. 7 such as, e.g., one or more user interface components (e.g., an input/output interface including a display, buttons, a touch screen, a microphone, a speaker(s), and/or the like and/or any other components for allowing input of information into the UE 700 and/or allowing output of information from the UE 700), a power supply (e.g., a battery and associated power circuitry), etc.

In some embodiments, a computer program including instructions which, when executed by at least one processor, causes the at least one processor to carry out the functionality of the UE 700 according to any of the embodiments described herein (e.g., one or more functions of the UE as described herein with respect to FIG. 2) is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 8 is a schematic block diagram of the UE 700 according to some other embodiments of the present disclosure. The UE 700 includes one or more modules 800, each of which is implemented in software. The module(s) 800 provide the functionality of the UE 700 described herein (e.g., one or more functions of the UE as described herein with respect to FIG. 2).

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Those skilled in the art will recognize improvements and modifications to the embodiments of the present disclosure. All such improvements and modifications are considered within the scope of the concepts disclosed herein.

1. A method performed by a wireless device for a cellular communications network, the method comprising:
determining a transmission gap for the wireless device, the transmission gap being a time gap during which no uplink or downlink data transmission is anticipated or required by the wireless device; and
transmitting information comprising an indication of the transmission gap to a network node.

2. The method of claim 1 wherein any transmission by the wireless device of any data generated during the time gap and any reception by the wireless device of any data generated during the time gap can be delayed until after the transmission gap.

3. The method of claim 1 wherein determining the transmission gap for the wireless device comprises determining a length of the transmission gap.

4. The method of claim 1 wherein the indication is a one-time indication of the transmission gap.

5. The method of claim 1 wherein the indication serves as an indication that the indicated transmission gap is valid in one or more upcoming Physical Downlink Control Channel, PDCCH, monitoring occasions.

6. The method of claim 1 wherein the indication of the transmission gap indicates a length of the transmission gap as a number of time slots.

7. The method of claim 1 wherein the indication of the transmission gap indicates a length of the transmission gap as a number of milliseconds.

8. The method of claim 1 further comprising receiving, from the network node, a PDCCH monitoring configuration message that changes a current PDCCH monitoring mode of the wireless device to a new PDCCH monitoring mode.

9. The method of claim 8 wherein the new PDCCH monitoring mode provides less frequent PDCCH monitoring occasions than the current PDCCH monitoring mode.

10. The method of claim 8 wherein the new PDCCH monitoring mode provides cross-slot scheduling.

11. The method of claim 1 further comprising receiving, from the network node, a PDCCH monitoring configuration message that changes a current PDCCH monitoring mode of the wireless device to a new PDCCH monitoring mode that grants the transmission gap indicated by the wireless device.

12. The method of claim 1 further comprising going into a sleep state for the transmission gap.

13. The method of claim 1 wherein determining the transmission gap comprises determining the transmission gap based on:
a. tolerated latency for a transmission,
b. predicted traffic burst arrival,
c. predicted uplink, UL, traffic burst, or
d. any combination of two or more of a-c.

14. The method of claim 1 wherein transmitting the information comprises transmitting the information over a Physical Uplink Control Channel, PUCCH, or a Physical Uplink Shared Channel, PUSCH.

15. The method of claim 1 wherein transmitting the information comprises transmitting the information in a Medium Access Control, MAC, Control Element, CE.

16. The method of claim 1 wherein the time gap is a remainder of a current Inter-Arrival Time, IAT, or a reminder of a current Connected Mode Discontinuous Reception, CDRX, period.

17. The method of claim 1 wherein the time gap extends to a beginning of a next Connected Mode Discontinuous Reception, CDRX, ON duration.

18. The method of claim 1 wherein the indication of the transmission gap is a dynamic indication.

19. The method of claim 1 wherein the indication of the transmission gap is a semi-static indication.

20. (canceled)

21. (canceled)

22. A wireless device for a cellular communications network, the wireless device comprising:
one or more transmitters;
one or more receivers; and
processing circuitry associated with the one or more transmitters and the one or more receivers, the processing circuitry configured to cause the wireless device to:
determine a transmission gap for the wireless device, the transmission gap being a time gap during which no uplink or downlink data transmission is anticipated or required by the wireless device; and
transmit information comprising an indication of the transmission gap to a network node.

23. A method performed by a base station for a cellular communications network, the method comprising:
receiving, from a wireless device, information comprising an indication of a transmission gap, the transmission gap being a time gap during which no uplink or downlink data transmission is anticipated or required by the wireless device;
determining a Physical Downlink Control Channel, PDCCH, monitoring mode for the wireless device to accommodate the indicated transmission gap; and
transmitting a configuration of the determined PDCCH monitoring mode to the wireless device.

24. The method of claim 23 wherein the configuration of the determined PDCCH monitoring mode comprises a Go-To-Sleep, GTS, signal that puts the wireless device in a lower energy consumption state for a duration of the indicated transmission gap.

25. The method of claim 23 wherein the configuration of the determined PDCCH monitoring mode includes a PDCCH skipping command that reduces energy consumption for a duration of the indicated transmission gap.

26. The method of claim 23 wherein the configuration of the determined PDCCH monitoring mode includes configuring a configuration of a sparser PDCCH search space that reduces energy consumption for a duration of the indicated transmission gap.

27. The method of claim 23 wherein the configuration of the determined PDCCH monitoring mode includes configuring a configuration of cross-slot scheduling that reduces energy consumption for a duration of the indicated transmission gap.

28. The method of claim 23 further comprising configuring the wireless device to transmit the information comprising the indication of the transmission gap to the base station.

29. The method of claim 23 further comprising configuring the wireless device to transmit the information comprising the indication of the transmission gap at an aperiodic rate.

30. (canceled)

31. (canceled)

32. A base station for a cellular communications network, the base station comprising processing circuitry configured to cause the base station to:
receive, from a wireless device, information comprising an indication of a transmission gap, the transmission gap being a time gap during which no uplink or downlink data transmission is anticipated or required by the wireless device;
determine a Physical Downlink Control Channel, PDCCH, monitoring mode for the wireless device to accommodate the indicated transmission gap; and
transmit a configuration of the determined PDCCH monitoring mode to the wireless device.
